(19) United States
(12) Patent Application Publication
(10) Pub. No.: US 2025/0004737 A1
(43) Pub. Date: Jan. 2, 2025

(54) Filtering third-party content related to applications based on installation status

(71) Applicant: Google LLC, Mountain View, CA (US)

(72) Inventor: Keun Soo Yim

(21) Appl. No.: 18/276,790

(22) PCT Filed: Nov. 1, 2022
(86) PCT No.: PCT/US22/48511

§ 371 Date: Aug. 10, 2023

(51) Int. Cl. G06F 8/61

(52) U.S. Cl. CPC G06F 8/61

(57) ABSTRACT

Techniques for filtering third-party content that is to be provided via a mobile computing device based on which applications are already installed on that mobile computing device are provided. An example method includes determining, by a server, a set of candidate mobile applications, including first and second applications, each associated with respective third-party content presentable on a mobile computing device; in response to determining that the first application is absent from a set of applications installed on the mobile computing device: sending, by the server to the mobile computing device, third-party content associated with the first application; and in response to determining that the second application is included in the set of applications installed on the mobile computing device: refraining from sending third-party content associated with the second application to the mobile computing device.

### FIELD OF THE DISCLOSURE

The present disclosure generally relates to mobile computing device applications and, more particularly, to techniques for filtering third-party content related to the installation of mobile applications that is to be provided via a given mobile computing device based on which applications are already installed on that mobile computing device.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Certain third-party content for mobile computing devices includes links to applications installable on a mobile computing device. Generally speaking, this third-party content is distributed to user devices by a remote server, which has no way of determining which mobile applications are installed on the various user devices to which it distributes third-party content. For this reason, the remote server may, in some cases, distribute third-party content related to mobile computing device applications that are already installed on a given user's mobile computing device and send them to that user's mobile computing device.

However, if a user already has an application installed on his or her mobile computing device, the user is unlikely to select a link to that app. That is, regardless of whether a mobile computing device user is interested in a given mobile computing device app, the user will be unlikely to click on third-party content link for that application if he or she already has the application installed on his or her mobile computing device.

### SUMMARY

In an embodiment, a computer-implemented method for filtering third-party content related to the installation of mobile applications that is to be provided via a given mobile computing device based on which applications are already installed on that mobile computing device, as may be implemented by a server, is provided. The method may include determining, by a server, a set of one or more candidate mobile applications, including a first mobile application and a second mobile application, each associated with respective third-party content presentable on a mobile computing device; in response to determining that the first mobile application is absent from a set of the one or more mobile applications installed on the mobile computing device: sending, by the server to the mobile computing device, third-party content associated with the first mobile application; and in response to determining that the second mobile application is included in the set of one or more mobile applications installed on the mobile computing device: refraining from sending third-party content associated with the second mobile application to the mobile computing device.

In another embodiment, a system for filtering third-party content related to the installation of mobile applications that is to be provided via a given mobile computing device based on which applications are already installed on that mobile computing device, as may be implemented by a server, is provided. The system may include one or more processors; and a memory, storing computer-readable instructions that, when executed by the one or more processors, cause the one or more processors to: determine a set of one or more candidate mobile applications, including a first mobile application and a second mobile application, each associated with respective third-party content presentable on a mobile computing device; in response to determining that the first mobile application is absent from a set of the one or more mobile applications installed on the mobile computing device: send third-party content associated with the first mobile application; and in response to determining that the second mobile application is included in the set of one or more mobile applications installed on the mobile computing device: refrain from sending third-party content associated with the second mobile application to the mobile computing device.

In still another embodiment, a non-transitory computer-readable medium storing instructions for filtering third-party content related to the installation of mobile applications that is to be provided via a given mobile computing device based on which applications are already installed on that mobile computing device, as may be implemented by a server, is provided. The instructions, when executed by one or more processors, may cause the one or more processors to determine a set of one or more candidate mobile applications, including a first mobile application and a second mobile application, each associated with respective third-party content presentable on a mobile computing device; in response to determining that the first mobile application is absent from a set of the one or more mobile applications installed on the mobile computing device: send third-party content associated with the first mobile application; and in response to determining that the second mobile application is included in the set of one or more mobile applications installed on the mobile computing device: refrain from sending third-party content associated with the second mobile application to the mobile computing device.

In an embodiment, a computer-implemented method for filtering third-party content related to the installation of mobile applications that is to be provided via a given mobile computing device based on which applications are already installed on that mobile computing device, as may be implemented by a mobile computing device is provided. The method may include determining, by a mobile computing device, an indication of a set of one or more mobile applications installed on the mobile computing device; receiving, by the mobile computing device, an indication of a set of one or more candidate mobile applications, including a first mobile application and a second mobile application, each associated with respective third-party content presentable on the mobile computing device; in response to determining that the first mobile application is absent from the set of the one or more mobile applications installed on the mobile computing device: presenting, by the mobile computing device, third-party content associated with the first mobile application; and in response to determining that the second mobile application is included in the set of one or more mobile applications installed on the mobile computing device: refraining from presenting, by the mobile computing device, third-party content associated with the second mobile application.

In another embodiment, a system for filtering third-party content related to the installation of mobile applications that is to be provided via a given mobile computing device based on which applications are already installed on that mobile computing device, as may be implemented by a mobile computing device, is provided. The system may include one or more processors; and a memory, storing computer-readable instructions that, when executed by the one or more processors, cause the one or more processors to: receive an indication of a set of one or more candidate mobile applications, including a first mobile application and a second mobile application, each associated with respective third-party content presentable on the mobile computing device; in response to determining that the first mobile application is absent from the set of the one or more mobile applications installed on the mobile computing device: present third-party content associated with the first mobile application; and in response to determining that the second mobile application is included in the set of one or more mobile applications installed on the mobile computing device: refrain from presenting, by the mobile computing device, third-party content associated with the second mobile application.

In still another embodiment, a non-transitory computer-readable medium storing instructions for filtering third-party content related to the installation of mobile applications that is to be provided via a given mobile computing device based on which applications are already installed on that mobile computing device, as may be implemented by a mobile computing device, is provided. The instructions, when executed by one or more processors, may cause the one or more processors to receive an indication of a set of one or more candidate mobile applications, including a first mobile application and a second mobile application, each associated with respective third-party content presentable on the mobile computing device; in response to determining that the first mobile application is absent from the set of the one or more mobile applications installed on the mobile computing device: present third-party content associated with the first mobile application; and in response to determining that the second mobile application is included in the set of one or more mobile applications installed on the mobile computing device: refrain from presenting, by the mobile computing device, third-party content associated with the second mobile application.

Refraining from sending third-party content may allow the reservation of bandwidth or data on mobile devices for other services. For example, refraining from sending third-party content may preserve bandwidth availability to a mobile device for other third party content or for other mobile device services. In addition, by refraining from sending certain third-party content which would otherwise not be presented on a mobile device, bandwidth of the connection to the mobile device and storage on the mobile device may be preserved. Refraining from presenting third-party content by the mobile computing device may allow for the preservation of mobile device processing power to carry out other processes.

### BRIEF DESCRIPTION OF THE DRAWINGS

FIG. 1 illustrates a block diagram of an example system that implements techniques of this disclosure for filtering third-party content related to the installation of mobile applications that is to be provided via a given mobile computing device based on which applications are already installed on that mobile computing device;

FIG. 2 illustrates a flow diagram of an example method for filtering third-party content related to the installation of mobile applications that is to be provided via a given mobile computing device based on which applications are already installed on that mobile computing device, implemented via a server device; and

FIG. 3 illustrates a flow diagram of an example method for filtering third-party content related to the installation of mobile applications that is to be provided via a given mobile computing device based on which applications are already installed on that mobile computing device, implemented via a mobile computing device.

### DETAILED DESCRIPTION

### Overview

The present disclosure relates to techniques for filtering third-party content related to the installation of mobile applications that is to be provided via a given mobile computing device based on which applications are already installed on that mobile computing device.

In one example, the mobile computing device (e.g., via a privileged system application such as Google Mobile Services (GMS) Core) monitors the application installation and uninstallation events that occur on the mobile computing device and periodically updates the remote server with an indication of which applications are currently installed on the mobile computing device. Accordingly, the server does not need to keep track of conversions, i.e., instead of trying to record previous instances of presenting third-party content and a conversion that lead to the installation of an app, the server can simply receive updates from the client.

This is done only with the permission of the user of the mobile computing device. The remote server stores the application installation information (e.g., key: device ID and user ID, value: a list of installed applications and package names associated therewith), which may be hashed in some cases to preserve user privacy. The third-party content items distributed by the remote server may include associated information that describes the package name of the application that will be installed based on the user selecting a link within the third-party content item (e.g., the landing page when the link within the third-party content item is clicked by users). When sending third-party content items to a mobile computing device, the remote server can filter out any third-party content items associated with package names matching the package names associated with the device ID and/or user ID of the mobile computing device and/or the user of the mobile computing device.

In another example, the mobile computing device monitors the application installation and uninstallation events that occur on the mobile computing device, but does not provide an indication of which applications are currently installed on the mobile computing device to the remote server. Instead, the remote server distributes multiple possible third-party content items to the mobile computing device, including associated information for each third-party content item that describes the package name of the application that will be installed based on the user selecting a link within the third-party content item. The mobile computing device can then filter out any third-party content items associated with package names matching applications already installed on the mobile computing device, or request additional third-party content items from the remote server if all of the third-party content items sent to the mobile computing device are for applications that are already installed on the mobile computing device.

Additionally, in some examples, a combination of these two methods may be used, in which the mobile computing device filters out third-party content items only for recently installed mobile computing device applications that were not included in the most recent update sent to the remote server.

### Example System

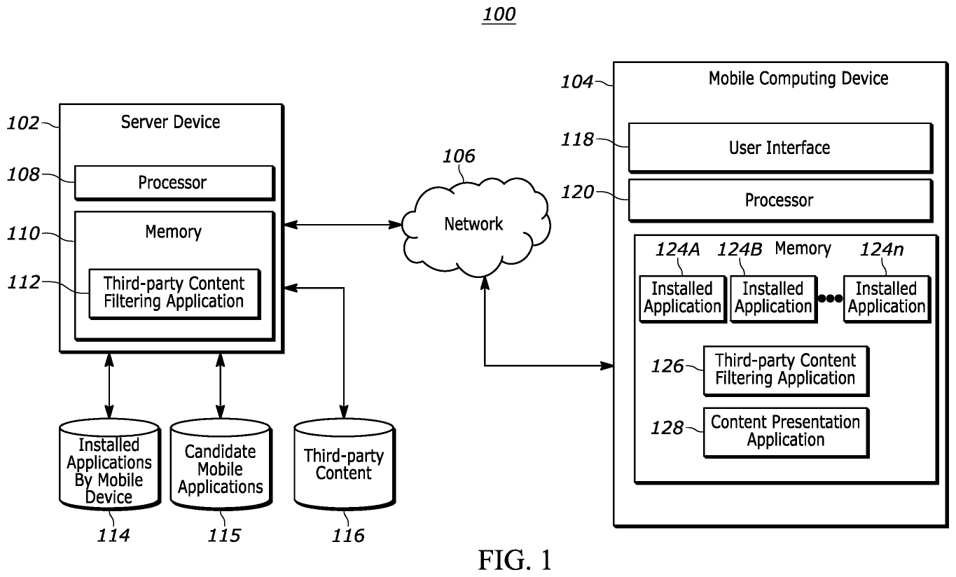

FIG. 1 is a block diagram of a system 100 for filtering third-party content related to the installation of mobile applications that is to be provided via a given mobile computing device based on which applications are already installed on that mobile computing device, in accordance with some examples provided herein. The high-level architecture illustrated in FIG. 1 may include both hardware and software applications, as well as various data communications channels for communicating data between the various hardware and software components, as is described below.

The system 100 may include a sever device 102 and a mobile computing device 104 (such as, e.g., a smart phone, tablet, smart watch, laptop computer, other personal computer, etc.), configured to communicate with one another, e.g., via a network 106, which may include a wired or wireless network.

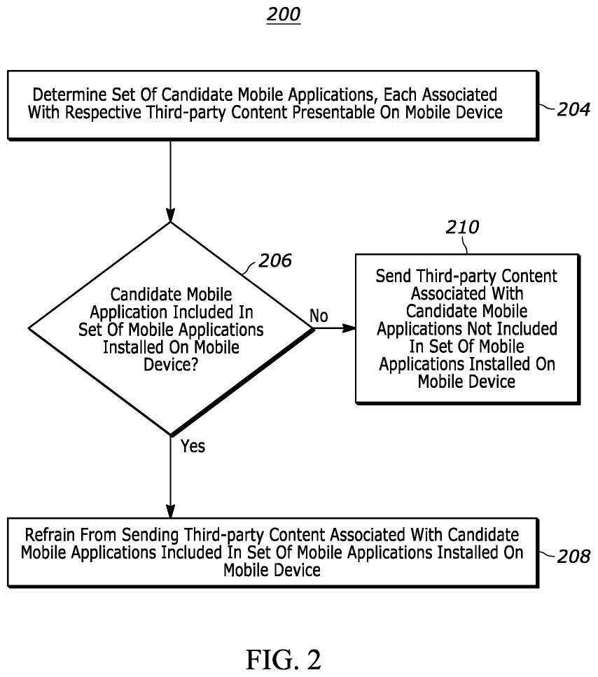

The server device 102 may include one or more processors 108, and a memory 110 (e.g., volatile memory, non-volatile memory). The memory 110 may be accessible by the one or more processors 108 (e.g., via a memory controller). The one or more processors 108 may interact with the memory 110 to obtain, for example, computer-readable instructions stored in the memory 110. The computer-readable instructions stored in the memory 110 may cause the one or more processors 108 to execute one or more applications, including, in some examples, a third-party content filtering application 112. Furthermore, in some examples, the computer-readable instructions stored on the memory 110 may include instructions for carrying out any of the steps of the method 200, described in greater detail below with respect to FIG. 2.

Generally speaking, executing the third-party content filtering application 112 may include sending third-party content to the mobile computing device 104, i.e., for presentation via the mobile computing device 104.

In some examples, the third-party content filtering application 112 may access datasets stored in the memory 110, such as datasets including indications of applications installed by various mobile computing devices such as the mobile computing device 104, indications of candidate mobile applications, and/or indications of third-party content associated with respective candidate mobile applications. Additionally or alternatively, the third-party content filtering application 112 may access external databases including one or more of these datasets or portions thereof, such as a database 114 storing indications of applications installed by various mobile computing devices such as the mobile computing device 104, a candidate mobile application database 115 storing data related to candidate mobile applications, and/or a third-party content database 116 storing data related to third-party content associated with respective candidate mobile applications.

The third-party content filtering application 112 may determine or otherwise identify a set of candidate mobile applications that are associated with third-party content that is presentable via the mobile computing device 104. For example, the third-party content filtering application 112 may access datasets or databases (115, 116) storing data related to candidate mobile applications and/or data related to third-party content associated with respective candidate mobile applications. For instance, in some examples, the third-party content may include advertisement content or informational content related to one or more of the candidate mobile applications. In some examples, the third-party content filtering application 112 may identify particular candidate mobile applications for a particular mobile computing device 104, or for a particular user of the mobile computing device 104, and/or particular third-party content associated with the candidate mobile applications for a particular user of the mobile computing device 104, e.g., based on additional data such as location data, demographic data, or other user data associated with the user of the mobile computing device 104 that is provided to the server device 102 based on the user of the mobile computing device 104 granting permission.

In some examples, the third-party content filtering application 112 may send these determined or identified items of third-party content, as well as an indication of candidate mobile applications associated with each item of third-party content, to the mobile computing device 104. For instance, in some examples, the third-party content filtering application 112 may subsequently receive a request from the mobile computing device 104 for additional items of third-party content associated with different (not necessarily specified) candidate mobile applications, and may send the additional items of third-party content, as well as an indication of candidate mobile applications associated with each item of third-party content, to the mobile computing device 104.

Furthermore, in some examples, the third-party content filtering application 112 may send a listing of candidate mobile applications to the mobile computing device 104, and may subsequently receive, in response from the mobile computing device 104, an indication of one or more of the candidate mobile applications that are not currently installed on the memory of the mobile computing device 104. The third-party content filtering application 112 may then send the determined or identified items of third-party content that are associated with the candidate applications that have not already been installed by the mobile computing device 104 to the mobile computing device 104.

Moreover, in some examples, the third-party content filtering application 112 may determine or receive an indication of which applications are installed by the mobile computing device 104 (that is provided to the server device 102 based on the user of the mobile computing device 104 granting permission), and may send the determined or identified items of third-party content that are associated with applications that are not already installed by the mobile computing device 104 to the mobile computing device 104. In some examples, the third-party content filtering application 112 may access a dataset or database 114 storing indications of applications downloaded and/or installed by various mobile computing devices such as the mobile computing device 104 in order to determine which applications are not already installed by the mobile computing device 104. For instance, in some examples, the database 114 may be populated by an application store or other application provider based on an application download history associated with the mobile computing device 104 (that is provided to the server device 102 based on the user of the mobile computing device 104 granting permission).

Furthermore, in some examples, the third-party content filtering application 112 may send a query or request to the mobile computing device 104 regarding which applications are currently installed on the memory of the mobile computing device 104, and the third-party content filtering application may subsequently receive (from the mobile computing device 104) an indication of one or more applications that are currently installed on the memory of the mobile computing device 104 (that is provided to the server device 102 based on the user of the mobile computing device 104 granting permission). Moreover, in some examples, the third-party content filtering application 112 may periodically receive updates of one or more applications that have been newly installed on the memory of the mobile computing device 104 (and/or one or more applications that have been newly uninstalled from the memory of the mobile computing device 104), in some cases regardless of whether the third-party content filtering application 112 sends a request for such updates to the mobile computing device 104.

For instance, in some examples, the third-party content filtering application 112 may compare the set of candidate mobile applications to the applications to the applications that the third-party content filtering application 112 has determined are installed by the mobile computing device 104, and may identify candidate applications that have not already been installed by the mobile computing device 104 (i.e., candidate applications that the third-party content filtering application 112 has not determined to have been installed by the mobile computing device 104). Furthermore, the third-party content filtering application 112 may send third-party content that is associated with the candidate applications that have not already been installed by the mobile computing device 104 to the mobile computing device 104. That is, in this example, the third-party content filtering application 112 may refrain from sending third-party content that is associated with the candidate applications that have already been installed by the mobile computing device 104 (i.e., based on the most recent updates received by the third-party content filtering application 112) to the mobile computing device 104.

Additionally, in some examples, the third-party content filtering application 112 (or another application of the server device 102) may receive, from the mobile computing device 104, indications of applications that are installed by the mobile computing device 104 after the mobile computing device 104 presents third-party content associated with various applications (provided to the server device 102 based on the user of the mobile computing device 104 granting permission). For instance, the server device 102 may receive an indication (from the mobile computing device 104) of whether an application associated with an item of third-party content was installed within a threshold period of time (e.g., 15 minutes, an hour, a day, a week, etc.) after the item of third-party content was presented by the mobile computing device 104, or may determine such an indication based on reports received from the mobile computing device 104.

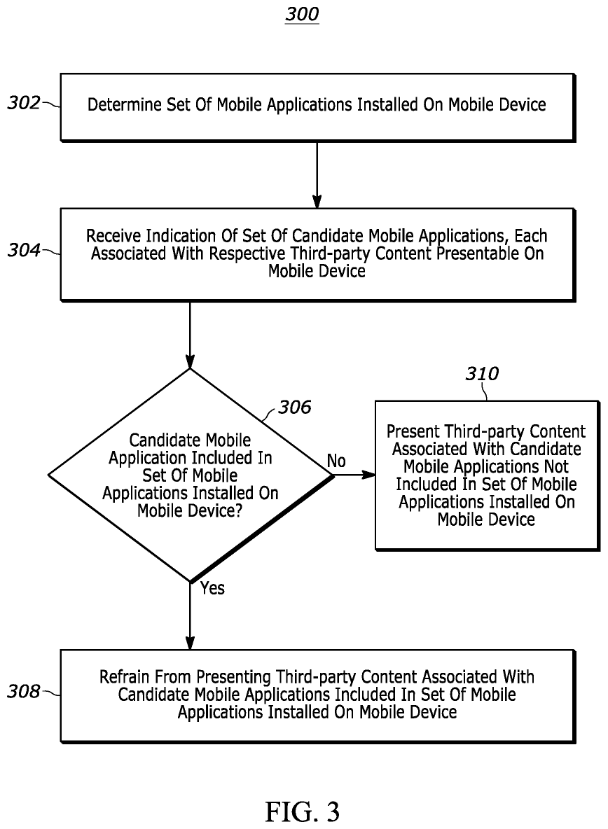

The mobile computing device 104 may include a user interface 118, one or more processors 120, and a memory 122 (e.g., volatile memory, non-volatile memory). The memory 122 may be accessible by the one or more processors 120 (e.g., via a memory controller). The one or more processors 120 may interact with the memory 122 to obtain, for example, computer-readable instructions stored in the memory 122. The computer-readable instructions stored in the memory 122 may cause the one or more processors 120 to execute one or more applications, including one or more various installed applications 124A, 124B, . . . 124N, a third-party content filtering application 126, and/or a content presentation application 128. Furthermore, in some examples, the computer-readable instructions stored on the memory 122 may include instructions for carrying out any of the steps of the method 300, described in greater detail below with respect to FIG. 3.

Executing the third-party content filtering application 126 may include identifying or otherwise determining which applications 124A, 124B, . . . 124N are currently installed on the mobile computing device 104. For simplicity, while the applications 124A, 124B, . . . 124N that are currently installed on the mobile computing device 104 may include the third-party content filtering application 126, and/or the content presentation application 128, along with a number of other mobile computing device applications, all of these applications may be collectively referred to as “the installed applications 124.” In some examples, the third-party content filtering application 126 may periodically identify or determine which installed applications 124 are currently present on the memory 122, and may generate a report indicating the installed applications 124 that are currently present on the memory 122. For instance, the report may include an indication of any of the installed applications 124 that have been added or removed since the previous report. In some examples, the third-party content filtering application 126 may send this report to the server device 102 (based on the user of the mobile computing device 104 granting permission), in some cases in response to requests that the third-party content filtering application 126 may receive from the server device 102.

Moreover, in some examples, the third-party content filtering application 126 may receive a listing of candidate mobile applications from the server device 102. The third-party content filtering application 126 may compare the listing of candidate mobile applications received from the server device 102 to the installed applications 124 in order to identify one or more candidate mobile applications that are not already installed on the mobile computing device 104. The third-party content filtering application 126 may subsequently send the server device 102 an indication of one or more of the candidate mobile applications that are not currently installed on the memory of the mobile computing device 104 (based on the user of the mobile computing device 104 granting permission).

In some examples, after sending this information to the server device 102, the third-party content filtering application 126 may subsequently receive items of third-party content from the server device 102 and may provide these items of third-party content to the content presentation application 128 for presentation via the user interface 118.

Additionally, in some examples, the third-party content filtering application 126 may receive items of third-party content, as well as indications of candidate mobile applications associated with each item of third-party content, from the server device 102. The third-party content filtering application 126 may compare the candidate mobile applications associated with each item of third-party content to the installed applications 124 in order to determine whether any of the candidate mobile applications are already installed on the memory of the mobile computing device 104. Upon identifying one or more items of third-party content that are associated with applications that are not already installed on the mobile computing device 104, the third-party content filtering application 126 may provide these identified items of third-party content to the content presentation application 128 for presentation via the user interface 118.

Furthermore, if all of the candidate mobile applications associated with the items of third-party content that the mobile computing device 104 receives from the server device 102 are already installed on the mobile computing device 104, the third-party content filtering application 126 may send a request to the server device 102 for additional items of third-party content, associated with different (not necessarily specified) candidate mobile applications. The third-party content filtering application 126 may then receive additional items of third-party content, associated with different candidate mobile applications, from the server device 102, and may repeat this process until the third-party content filtering application 126 identifies one or more items of third-party content that are associated with applications that are not already installed on the mobile computing device 104. The third-party content filtering application 126 may provide these identified items of third-party content that are not already installed on the mobile computing device 104 to the content presentation application 128 for presentation via the user interface 118.

For instance, executing the content presentation application 128 may include presenting content including media content, web content, game content, etc., as well as third-party content from the third-party content filtering application 126, via the user interface 118. In some examples, the content provided by the content presentation application 128 via the user interface 118 may include audio content, video content, haptic content, etc.

Additionally, in some examples, the third-party content filtering application 126 (or another application of the mobile computing device 104) may send indications of applications that are installed by the mobile computing device 104 after the mobile computing device 104 presents third-party content associated with various applications (based on the user of the mobile computing device 104 granting permission). For instance, the mobile computing device 104 may send an indication of whether an application associated with an item of third-party content was installed on the memory 122 of the mobile computing device 104 within a threshold period of time (e.g., 15 minutes, an hour, a day, a week, etc.) after the item of third-party content was presented by the mobile computing device 104.

### Example Method in a Server Device

FIG. 2 is a flow diagram of an example method 200 for filtering third-party content related to the installation of mobile applications that is to be provided via a given mobile computing device based on which applications are already installed on that mobile computing device, implemented via a server device, as may be used in the system 100 of FIG. 1, in accordance with some examples provided herein. One or more steps of the method 200 may be implemented as a set of instructions stored on a computer-readable memory (e.g., memory 110 of the server device 102) and executable on one or more processors (e.g., processor 108 of the server device 102).

At block 204, the method 200 may include determining, by a server device (e.g., the server device 102), a set of one or more candidate mobile applications, each associated with respective third-party content presentable on a mobile computing device (e.g., the mobile computing device 104).

At block 206, a determination may be made as to whether one or more of the set of candidate mobile applications are included in the set of one or more mobile computing device applications installed on the mobile computing device.

For instance, in some examples, the method 200 may include receiving an indication of one or more mobile applications installed on the mobile computing device, from the mobile computing device, and the determination at block 206 may be based on the indication of one or more applications installed on the mobile computing device as received from the mobile computing device itself. For example, the mobile computing device may periodically (in response to requests from the server device or otherwise) send updated indications of mobile applications installed on the mobile computing device. Additionally, in some examples, the method 200 may include determining an indication of one or more mobile applications installed on the mobile computing device based on data provided by a mobile application store or provider accessed by the mobile computing device. For instance, the data provided by the mobile application store or provider may include an indication of which mobile applications were purchased by and/or downloaded by the mobile computing device, and the determination made at block 206 may be based on the indication of one or more applications installed on the mobile computing device as determined based on the data provided by the mobile application store or provider.

Additionally, in some examples, the method 200 may include the server device sending an indication of the set of candidate mobile applications to the mobile computing device. The mobile computing device may respond to the indication of candidate mobile applications sent by the server device by sending an indication of one or more of the candidate mobile applications that are installed on the mobile computing device, and/or sending an indication of one or more of the candidate mobile applications that are not installed on the mobile computing device, i.e., such that the method 200 includes the server device receiving an indication of one or more of the candidate mobile applications that are installed on the mobile computing device, and/or sending an indication of one or more of the candidate mobile applications that are not installed on the mobile computing device.

If one or more of the set of candidate mobile applications are included in the set of one or more mobile computing device applications installed on the mobile computing device (block 206, YES) the method 200 may include refraining (block 208) from sending third-party content associated with those mobile applications to the mobile computing device.

If one or more of the set of candidate mobile applications are not included in the set of one or more mobile computing device applications installed on the mobile computing device (block 206, NO) the method 200 may include sending (block 210) third-party content associated with one or more of those mobile applications to the mobile computing device.

Additionally, in some examples, the method 200 may further include receiving or otherwise determining an updated indication of one or more mobile applications installed on the mobile computing device. For instance, the updated indication of the one or more applications installed on the mobile computing device may indicate that one of the applications previously determined to be absent from the mobile computing device were actually present on the mobile computing device prior to third-party content associated with that application being sent to the mobile computing device (e.g., because the previous indication/determination of the one or more applications installed on the mobile computing device was out of date). In such cases, the method 200 may include the server device sending third-party content associated with another mobile application that is not present on the mobile computing device according to the updated indication of the one or more applications installed on the mobile computing device.

Furthermore, in some examples, the updated indication of the one or more applications installed on the mobile computing device may indicate that one or more of the mobile applications previously determined to be present on the mobile computing device are now absent from the mobile computing device (e.g., because the these applications were uninstalled from the mobile computing device since the previous indication/determination of the one or more applications installed on the mobile computing device). In such cases, the method 200 may include the server device sending third-party content associated with one of the mobile applications that are newly determined to be absent from the mobile computing device.

Additionally, in some examples, the updated indication of the one or more applications installed on the mobile computing device may indicate that one or more mobile applications for which associated third-party content was sent to the mobile computing device have subsequently been installed on the mobile computing device. In particular, the updated indication of the one or more applications installed on the mobile computing device may include an indication that the one or more mobile applications for which associated third-party content was sent to the mobile computing device have subsequently been installed on the mobile computing device, e.g., within a threshold amount of time (e.g., 15 minutes, one hour, one day, one week) after the third-party content was presented via the mobile computing device.

### Example Method in a Mobile Computing Device

FIG. 3 is a flow diagram of an example method 300 for filtering third-party content related to the installation of mobile applications that is to be provided via a given mobile computing device based on which applications are already installed on that mobile computing device, implemented via a mobile computing device, as may be used in the system 100 of FIG. 1, in accordance with some examples provided herein. One or more steps of the method 300 may be implemented as a set of instructions stored on a computer-readable memory (e.g., memory 122 of the mobile computing device 104) and executable on one or more processors (e.g., processor 120 of the mobile computing device 104).

At block 302, the method 300 may include determining, by a mobile computing device (e.g., the mobile computing device 104), an indication of a set of one or more mobile applications installed on the mobile computing device.

At block 304, the method 300 may include receiving, by the mobile computing device, an indication of a set of one or more candidate mobile applications, each associated with respective third-party content presentable on the mobile computing device, e.g., from a server device such as the server device 102. In some examples, the mobile computing device may also receive third-party content associated with one or more of the candidate mobile applications, e.g., from the server device.

At block 306, a determination may be made as to whether one or more of the set of candidate mobile applications are included in the set of one or more mobile computing device applications installed on the mobile computing device.

If one or more of the set of candidate mobile applications are included in the set of one or more mobile computing device applications installed on the mobile computing device (block 306, YES) the method 300 may include refraining (block 308) from presenting third-party content associated with those mobile applications. If one or more of the candidate mobile applications are subsequently uninstalled from the mobile computing device, or otherwise removed from the mobile computing device, the method 300 may further include subsequently presenting third-party content associated with those candidate mobile applications. For instance, in some examples, the method 300 may include the mobile computing device requesting third-party content associated with those candidate mobile applications, e.g., from the server device, and subsequently receiving and presenting the third-party content associated with those candidate mobile applications.

If one or more of the set of candidate mobile applications are not included in the set of one or more mobile computing device applications installed on the mobile computing device (block 306, NO) the method 300 may include presenting (block 310) third-party content associated with one or more of those mobile applications, e.g., via a user interface (such as the user interface 118) associated with the mobile computing device. For instance, in some examples, the method 300 may include the mobile computing device requesting third-party content associated with one or more candidate mobile applications that are not installed on the mobile computing device from the server device. The mobile computing device may subsequently receive and present the third-party content associated with the one or more candidate mobile applications that are not installed on the mobile computing device.

In some examples, the method 300 may include sending an update to the server device indicating that one or more mobile applications for which associated third-party content was presented by the mobile computing device have subsequently been installed on the mobile computing device. In particular, the update may include an indication that the one or more mobile applications for which associated third-party content was sent to the mobile computing device have subsequently been installed on the mobile computing device, e.g., within a threshold amount of time (e.g., 15 minutes, one hour, one day, one week) after the mobile computing device presented the third-party content.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

A hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module in dedicated and permanently configured circuitry or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The following is a non-exhaustive list of aspects of the present disclosure:

Aspect 1. A computer-implemented method, comprising:
determining, by a server, a set of one or more candidate mobile applications, including a first mobile application and a second mobile application, each associated with respective third-party content presentable on a mobile computing device;
in response to determining that the first mobile application is absent from a set of one or more mobile applications installed on the mobile computing device:
   sending, by the server to the mobile computing device, third-party content associated with the first mobile application; and
in response to determining that the second mobile application is included in the set of one or more mobile applications installed on the mobile computing device:
   refraining from sending third-party content associated with the second mobile application to the mobile computing device.

Aspect 2. The method of aspect 1, further comprising:
receiving, by the server from the mobile computing device, an indication of one or more mobile applications installed on the mobile computing device.

Aspect 3. The method of aspect 1, further comprising:
determining, by the server, an indication of one or more mobile applications installed on the mobile computing device based on data provided by a mobile application store or provider accessed by the mobile computing device.

Aspect 4. The method of any preceding aspect, further comprising:
sending, by the server, an indication of the set of one or more candidate mobile applications to the mobile computing device; and
receiving, by the server, an indication of one or more of: (i) the first mobile application being absent from the set of one or more mobile applications installed on the mobile computing device or (ii) the second mobile application being included in the set of one or more mobile applications installed on the mobile computing device.

Aspect 5. The method of any preceding aspect, wherein the set of one or more candidate mobile applications further includes a third mobile application, and further comprising:
receiving, by the server from the mobile computing device, an updated indication of one or more mobile applications installed on the mobile computing device, indicating that the first mobile application was installed on the mobile computing device prior to the mobile computing device receiving the third-party content associated with the first mobile application; and
sending, by the server to the mobile computing device, in response to determining that the third mobile application is absent from the set of one or more mobile applications installed on the mobile computing device, third-party content associated with the third mobile application.

Aspect 6. The method of any preceding aspect, further comprising:
receiving, by the server from the mobile computing device, an updated indication of one or more mobile applications installed on the mobile computing device, indicating that the first mobile application was installed on the mobile computing device within a threshold period of time, subsequent to the mobile computing device presenting the third-party content associated with the first mobile application.

Aspect 7. The method of any preceding aspect, further comprising:
receiving, by the server from the mobile computing device, an updated indication of one or more mobile applications installed on the mobile computing device, indicating that the second mobile application was uninstalled from the mobile computing device; and
sending, by the server to the mobile computing device, in response to determining that the second mobile application is absent from the set of one or more mobile applications installed on the mobile computing device, third-party content associated with the second mobile application.

Aspect 8. A system, comprising:
one or more processors; and
a memory, storing computer-readable instructions that, when executed by the one or more processors, cause the one or more processors to:
   determine a set of one or more candidate mobile applications, including a first mobile application and a second mobile application, each associated with respective third-party content presentable on a mobile computing device;
   in response to determining that the first mobile application is absent from a set of one or more mobile applications installed on the mobile computing device:
      send third-party content associated with the first mobile application; and
   in response to determining that the second mobile application is included in the set of one or more mobile applications installed on the mobile computing device:
      refrain from sending third-party content associated with the second mobile application to the mobile computing device.

Aspect 9. The system of aspect 8, wherein the instructions, when executed by the one or more processors, further cause the one or more processors to:
receive an indication of one or more mobile applications installed on the mobile computing device, and optionally wherein the indication of one or more mobile applications installed on the mobile computing device is received from the mobile computing device.

Aspect 10. The system of aspect 8, wherein the instructions, when executed by the one or more processors, further cause the one or more processors to:
determine an indication of one or more mobile applications installed on the mobile computing device based on data provided by a mobile application store or provider accessed by the mobile computing device.

Aspect 11. The system of any of aspects 8 to 10, wherein the instructions, when executed by the one or more processors, further cause the one or more processors to:
send an indication of the set of one or more candidate mobile applications to the mobile computing device; and
receive an indication of one or more of: (i) the first mobile application being absent from the set of one or more mobile applications installed on the mobile computing device or (ii) the second mobile application being included in the set of one or more mobile applications installed on the mobile computing device, and optionally wherein the indication of one or more of: (i) the first mobile application being absent from the set of one or more mobile applications installed on the mobile computing device or (ii) the second mobile application being included in the set of one or more mobile applications installed on the mobile computing device is received from the mobile computing device.

Aspect 12. The system of any of aspects 8 to 11, wherein the set of one or more candidate mobile applications further includes a third mobile application, wherein the instructions, when executed by the one or more processors, further cause the one or more processors to:
receive, from the mobile computing device, an updated indication of one or more mobile applications installed on the mobile computing device, indicating that the first mobile application was installed on the mobile computing device prior to the mobile computing device receiving the third-party content associated with the first mobile application; and
send, to the mobile computing device, in response to determining that the third mobile application is absent from the set of one or more mobile applications installed on the mobile computing device, third-party content associated with the third mobile application.

Aspect 13. The system of any of aspects 8 to 12, wherein the instructions, when executed by the one or more processors, further cause the one or more processors to:
receive an updated indication of one or more mobile applications installed on the mobile computing device, indicating that the first mobile application was installed on the mobile computing device within a threshold period of time, subsequent to the mobile computing device presenting the third-party content associated with the first mobile application, and optionally wherein the updated indication is received from the mobile computing device.

Aspect 14. The system of any of aspects 8 to 13, wherein the instructions, when executed by the one or more processors, further cause the one or more processors to:
receive, from the mobile computing device, an updated indication of one or more mobile applications installed on the mobile computing device, indicating that the second mobile application was uninstalled from the mobile computing device; and
send, to the mobile computing device, in response to determining that the second mobile application is absent from the set of one or more mobile applications installed on the mobile computing device, third-party content associated with the second mobile application.

Aspect 15. A computer-readable medium storing instructions that, when executed by one or more processors, cause the one or more processors to carry out the method of any of aspects 1 to 7.

Aspect 16. A computer-implemented method, comprising:
determining, by a mobile computing device, an indication of a set of one or more mobile applications installed on the mobile computing device;
receiving, by the mobile computing device, an indication of a set of one or more candidate mobile applications, including a first mobile application and a second mobile application, each associated with respective third-party content presentable on the mobile computing device;
in response to determining that the first mobile application is absent from the set of the one or more mobile applications installed on the mobile computing device:
   presenting, by the mobile computing device, third-party content associated with the first mobile application; and
in response to determining that the second mobile application is included in the set of one or more mobile applications installed on the mobile computing device:
   refraining from presenting, by the mobile computing device, third-party content associated with the second mobile application.

Aspect 17. The method of aspect 16, further comprising:
in response to determining that the first mobile application is absent from the set of the one or more mobile applications installed on the mobile computing device,
   requesting, by the mobile computing device, the third-party content associated with the first mobile application from the server; and receiving, by the mobile computing device, from the server, the third-party content associated with the first mobile application.

Aspect 18. The method of aspect 16, further comprising:
receiving, by the mobile computing device, from the server, the third-party content associated with the first mobile application, and the third-party content associated with the second mobile application.

Aspect 19. The method of any of aspects 16 to 18, further comprising:
sending, by the mobile computing device, to the server, an updated indication of one or more mobile applications installed on the mobile computing device, indicating that the first mobile application was installed on the mobile computing device within a threshold period of time, subsequent to the mobile computing device presenting the third-party content associated with the first mobile application.

Aspect 20. The method of any of aspects 16 to 19, further comprising:
determining, by the mobile computing device, that the second mobile application was uninstalled from the mobile computing device; and
in response to determining that the second mobile application is absent from the set of the one or more mobile applications installed on the mobile computing device:
   presenting, by the mobile computing device, third-party content associated with the second mobile application.

Aspect 21. The method of aspect 20, further comprising:
in response to determining that the second mobile application is absent from the set of the one or more mobile applications installed on the mobile computing device,
   requesting, by the mobile computing device, the third-party content associated with the second mobile application from the server; and receiving, by the mobile computing device, from the server, the third-party content associated with the second mobile application.

Aspect 22. A system, comprising:
one or more processors; and
a memory, storing computer-readable instructions that, when executed by the one or more processors, cause the one or more processors to:
determine an indication of a set of one or more mobile applications installed on the mobile computing device;
receive an indication of a set of one or more candidate mobile applications, including a first mobile application and a second mobile application, each associated with respective third-party content presentable on the mobile computing device;
in response to determining that the first mobile application is absent from the set of the one or more mobile applications installed on the mobile computing device:
   present third-party content associated with the first mobile application; and
in response to determining that the second mobile application is included in the set of one or more mobile applications installed on the mobile computing device:
   refrain from presenting, by the mobile computing device, third-party content associated with the second mobile application.

Aspect 23. The system of aspect 22, wherein the instructions, when executed by the one or more processors, further cause the one or more processors to:
in response to determining that the first mobile application is absent from the set of the one or more mobile applications installed on the mobile computing device,
   request the third-party content associated with the first mobile application from the server; and
receive from the server, the third-party content associated with the first mobile application.

Aspect 24. The system of aspect 22, wherein the instructions, when executed by the one or more processors, further cause the one or more processors to:
receive, from the server, the third-party content associated with the first mobile application, and the third-party content associated with the second mobile application.

Aspect 25. The system of any of aspects 22 to 24, wherein the instructions, when executed by the one or more processors, further cause the one or more processors to:
send to the server an updated indication of one or more mobile applications installed on the mobile computing device, indicating that the first mobile application was installed on the mobile computing device within a threshold period of time, subsequent to the mobile computing device presenting the third-party content associated with the first mobile application.

Aspect 26. The system of any of aspects 22 to 25, wherein the instructions, when executed by the one or more processors, further cause the one or more processors to:
determine that the second mobile application was uninstalled from the mobile computing device; and
in response to determining that the second mobile application is absent from the set of the one or more mobile applications installed on the mobile computing device:
   present third-party content associated with the second mobile application.

Aspect 27. The system of aspect 25, wherein the instructions, when executed by the one or more processors, further cause the one or more processors to:
in response to determining that the second mobile application is absent from the set of the one or more mobile applications installed on the mobile computing device,
   request the third-party content associated with the second mobile application from the server; and
receive, from the server, the third-party content associated with the second mobile application.

Aspect 28. A computer-readable medium storing instructions that, when executed by one or more processors, cause the one or more processors to carry out the method of any of aspects 16 to 21.

1. A computer-implemented method, comprising:
determining, by a server, a set of one or more candidate mobile applications, including a first mobile application and a second mobile application, each associated with respective third-party content presentable on a mobile computing device;
in response to determining that the first mobile application is absent from a set of one or more mobile applications installed on the mobile computing device:
sending, by the server to the mobile computing device, third-party content associated with the first mobile application; and
in response to determining that the second mobile application is included in the set of one or more mobile applications installed on the mobile computing device:
refraining from sending third-party content associated with the second mobile application to the mobile computing device.

2. The method of claim 1, further comprising:
receiving, by the server from the mobile computing device, an indication of one or more mobile applications installed on the mobile computing device.

3. The method of claim 1, further comprising:
determining, by the server, an indication of one or more mobile applications installed on the mobile computing device based on data provided by a mobile application store or provider accessed by the mobile computing device.

4. The method of claim 1, further comprising:
sending, by the server, an indication of the set of one or more candidate mobile applications to the mobile computing device; and
receiving, by the server, an indication of one or more of: (i) the first mobile application being absent from the set of one or more mobile applications installed on the mobile computing device or (ii) the second mobile application being included in the set of one or more mobile applications installed on the mobile computing device.

5. The method of claim 1, wherein the set of one or more candidate mobile applications further includes a third mobile application, and further comprising:
receiving, by the server from the mobile computing device, an updated indication of one or more mobile applications installed on the mobile computing device, indicating that the first mobile application was installed on the mobile computing device prior to the mobile computing device receiving the third-party content associated with the first mobile application; and
sending, by the server to the mobile computing device, in response to determining that the third mobile application is absent from the set of one or more mobile applications installed on the mobile computing device, third-party content associated with the third mobile application.

6. The method of claim 1, further comprising:
receiving, by the server from the mobile computing device, an updated indication of one or more mobile applications installed on the mobile computing device, indicating that the first mobile application was installed on the mobile computing device within a threshold period of time, subsequent to the mobile computing device presenting the third-party content associated with the first mobile application.

7. The method of claim 1, further comprising:
receiving, by the server from the mobile computing device, an updated indication of one or more mobile applications installed on the mobile computing device, indicating that the second mobile application was uninstalled from the mobile computing device; and
sending, by the server to the mobile computing device, in response to determining that the second mobile application is absent from the set of one or more mobile applications installed on the mobile computing device, third-party content associated with the second mobile application.

8. A system, comprising:
one or more processors; and
a memory, storing computer-readable instructions that, when executed by the one or more processors, cause the one or more processors to:
determine a set of one or more candidate mobile applications, including a first mobile application and a second mobile application, each associated with respective third-party content presentable on a mobile computing device;
in response to determining that the first mobile application is absent from a set of one or more mobile applications installed on the mobile computing device:
send third-party content associated with the first mobile application; and
in response to determining that the second mobile application is included in the set of one or more mobile applications installed on the mobile computing device:
refrain from sending third-party content associated with the second mobile application to the mobile computing device.

9. The system of claim 8, wherein the instructions, when executed by the one or more processors, further cause the one or more processors to:
receive an indication of one or more mobile applications installed on the mobile computing device.

10. The system of claim 8, wherein the instructions, when executed by the one or more processors, further cause the one or more processors to:
determine an indication of one or more mobile applications installed on the mobile computing device based on data provided by a mobile application store or provider accessed by the mobile computing device.

11. The system of claim 8, wherein the instructions, when executed by the one or more processors, further cause the one or more processors to:
send an indication of the set of one or more candidate mobile applications to the mobile computing device; and
receive an indication of one or more of: (i) the first mobile application being absent from the set of one or more mobile applications installed on the mobile computing device or (ii) the second mobile application being included in the set of one or more mobile applications installed on the mobile computing device.

12. The system of claim 8, wherein the set of one or more candidate mobile applications further includes a third mobile application, wherein the instructions, when executed by the one or more processors, further cause the one or more processors to:
receive, from the mobile computing device, an updated indication of one or more mobile applications installed on the mobile computing device, indicating that the first mobile application was installed on the mobile computing device prior to the mobile computing device receiving the third-party content associated with the first mobile application; and
send, to the mobile computing device, in response to determining that the third mobile application is absent from the set of one or more mobile applications installed on the mobile computing device, third-party content associated with the third mobile application.

13. The system of claim 8, wherein the instructions, when executed by the one or more processors, further cause the one or more processors to:
receive an updated indication of one or more mobile applications installed on the mobile computing device, indicating that the first mobile application was installed on the mobile computing device within a threshold period of time, subsequent to the mobile computing device presenting the third-party content associated with the first mobile application.

14. The system of claim 8, wherein the instructions, when executed by the one or more processors, further cause the one or more processors to:
receive, from the mobile computing device, an updated indication of one or more mobile applications installed on the mobile computing device, indicating that the second mobile application was uninstalled from the mobile computing device; and
send, to the mobile computing device, in response to determining that the second mobile application is absent from the set of one or more mobile applications installed on the mobile computing device, third-party content associated with the second mobile application.

15. A non-transitory, computer-readable medium storing instructions that, when executed by one or more processors, cause the one or more processors to:
determine a set of one or more candidate mobile applications, including a first mobile application and a second mobile application, each associated with respective third-party content presentable on a mobile computing device;
in response to determining that the first mobile application is absent from a set of the one or more mobile applications installed on the mobile computing device:
send third-party content associated with the first mobile application; and
in response to determining that the second mobile application is included in the set of one or more mobile applications installed on the mobile computing device:
refrain from sending third-party content associated with the second mobile application to the mobile computing device.

16. The non-transitory, computer-readable medium of claim 15, wherein the instructions, when executed by the one or more processors, further cause the one or more processors to:
receive an indication of one or more mobile applications installed on the mobile computing device.

17. The non-transitory, computer-readable medium of claim 15, wherein the instructions, when executed by the one or more processors, further cause the one or more processors to:
determine an indication of one or more mobile applications installed on the mobile computing device based on data provided by a mobile application store or provider accessed by the mobile computing device.

18. The non-transitory, computer-readable medium of claim 15, wherein the instructions, when executed by the one or more processors, further cause the one or more processors to:
send an indication of the set of one or more candidate mobile applications to the mobile computing device; and
receive an indication of one or more of: (i) the first mobile application being absent from the set of one or more mobile applications installed on the mobile computing device or (ii) the second mobile application being included in the set of one or more mobile applications installed on the mobile computing device.

19. The non-transitory, computer-readable medium of claim 15, wherein the set of one or more candidate mobile applications further includes a third mobile application, wherein the instructions, when executed by the one or more processors, further cause the one or more processors to:
receive, from the mobile computing device, an updated indication of one or more mobile applications installed on the mobile computing device, indicating that the first mobile application was installed on the mobile computing device prior to the mobile computing device receiving the third-party content associated with the first mobile application; and
send, to the mobile computing device, in response to determining that the third mobile application is absent from the set of one or more mobile applications installed on the mobile computing device, third-party content associated with the third mobile application.

20. The non-transitory, computer-readable medium of claim 15, wherein the instructions, when executed by the one or more processors, further cause the one or more processors to:
receive an updated indication of one or more mobile applications installed on the mobile computing device, indicating that the first mobile application was installed on the mobile computing device within a threshold period of time, subsequent to the mobile computing device presenting the third-party content associated with the first mobile application.

21.-39. (canceled)
